(19) United States
(12) Patent Application Publication
(10) Pub. No.: US 2002/0066196 A1
(43) Pub. Date: Jun. 6, 2002

(54) Combination square for large square tubing

(76) Inventor: Daniel O. Flint, Goldsboro, NC (US)

Correspondence Address: Joseph N. Breaux, Suite A, 10630 N. Oak Hills Pkwy., Baton Rouge, LA, 70810, US

(21) Appl. No.: 09/731,364

(22) Filed: Dec. 6, 2000

(51) Int. Cl. B43L 7/00

(52) U.S. Cl. 33/480; 248/314

(57) ABSTRACT

A combination square having planar contact surfaces greater than one and one-half inches in width so that a sufficient section of the squares contact surfaces make contact with the sides of the tubing for accurate measurements to be made. The contact surfaces are formed on a base member bracket and include a planar, vertical contact face; a planar bottom contact face oriented at a ninety degree angle with respect to the vertical contact face and having a first end edge in connection with a vertical bottom end edge of the vertical contact face, and a planar forty-five degree contact face oriented at a forty-five degree angle with respect to the vertical contact face and the bottom contact face and having an angled bottom end edge in connection with a second end edge of the bottom contact face.

### TECHNICAL FIELD

The present invention relates to adjustable combination squares and more particularly to a combination square for large square tubing that includes a base assembly and an adjustable ruler member securable to the base assembly; the base assembly including a base member bracket, a ruler member securing assembly for securing the ruler member at a desired orientation angle, a level vial held within a vial holding bracket of the base member bracket, and a scratch awl removably securable to the base member bracket; the base member bracket including a planar, vertical contact face having a width greater than one and one-half inches, a planar bottom contact face oriented at a ninety degree angle with respect to the vertical contact face and having a first end edge in connection with a vertical bottom end edge of the vertical contact face, a planar forty-five degree contact face oriented at a forty-five degree angle with respect to the vertical contact face and the bottom contact face and having an angled bottom end edge in connection with a second end edge of the bottom contact face, and a ruler member receiving slot formed entirely through the bottom contact face and through bottom sections of the vertical contact face and the forty-five degree contact face sized to receive a section of the ruler member at an orientation angle of between zero and twenty-two and one-half degrees; the ruler member being held at the desired angle by the ruler member securing assembly.

### BACKGROUND OF ART

Welders often have to use a combination square when constructing items from square metal tubing. Although conventional combination squares work well on small size square metal tubing, they do not work on large size square metal tubing because the sides edges of the square metal tubing are actually rounded and the large size square metal tubing has curved sides that are too large to allow a welder to use a conventional combination square. It would be desirable, therefore, to have a combination square having planar contact surfaces greater than one and one-half inches in width so that a sufficient section of the squares contact surfaces make contact with the sides of the tubing for accurate measurements to be made.

### GENERAL SUMMARY DISCUSSION OF INVENTION

It is thus an object of the invention to provide a combination square for large square tubing that includes a base assembly and an adjustable ruler member securable to the base assembly; the base assembly including a base member bracket, a ruler member securing assembly for securing the ruler member at a desired orientation angle, a level vial held within a vial holding bracket of the base ember bracket, and a scratch awl removably securable to the base member bracket; the base member bracket including a planar, vertical contact face having a width greater than one and one-half inches, a planar bottom contact face oriented at a ninety degree angle with respect to the vertical contact face and having a first end edge in connection with a vertical bottom end edge of the vertical contact face, a planar forty-five degree contact face oriented at a forty-five degree angle with respect to the vertical contact face and the bottom contact face and having an angled bottom end edge in connection with a second end edge of the bottom contact face, and a ruler member receiving slot formed entirely through the bottom contact face and through bottom sections of the vertical contact face and the forty-five degree contact face sized to receive a section of the ruler member at an orientation angle of between zero and twenty-two and one-half degrees; the ruler member being held at the desired angle by the ruler member securing assembly.

Accordingly, a combination square for large square tubing is provided. The combination square for large square tubing includes a base assembly and an adjustable ruler member securable to the base assembly; the base assembly including a base member bracket, a ruler member securing assembly for securing the ruler member at a desired orientation angle, a level vial held within a vial holding bracket of the base member bracket, and a scratch awl removably securable to the base member bracket; the base member bracket including a planar, vertical contact face having a width greater than one and one-half inches, a planar bottom contact face oriented at a ninety degree angle with respect to the vertical contact face and having a first end edge in connection with a vertical bottom end edge of the vertical contact face, a planar forty-five degree contact face oriented at a forty-five degree angle with respect to the vertical contact face and the bottom contact face and having an angled bottom end edge in connection with a second end edge of the bottom contact face, and a ruler member receiving slot formed entirely through the bottom contact face and through bottom sections of the vertical contact face and the forty-five degree contact face sized to receive a section of the ruler member at an orientation angle of between zero and twenty-two and one-half degrees; the ruler member being held at the desired angle by the ruler member securing assembly.

### BRIEF DESCRIPTION OF THE DRAWINGS

For a further understanding of the nature and objects of the present invention, reference should be made to the following detailed description, taken in conjunction with the accompanying drawings, in which like elements are given the same or analogous reference numbers and wherein:

FIG. 1 is a side plan view of an exemplary embodiment of the combination square for large square tubing of the present invention showing the base assembly and the adjustable ruler member secured at a 90 degree angle with respect to the vertical contact face of the base member bracket; the angular range of motion of the adjustable ruler member being shown by the ruler member in dashed lines.

FIG. 2 is a side plan view of the combination square for large square tubing of FIG. 1 showing the ruler pivoting slot formed into the forty-five degree contact face of the base member bracket and the adjustable ruler member secured at the same angle as shown in FIG. 1.

FIG. 3 is a partial top plan view showing the end of a section of large square tubing with a section of the vertical contact face of the base bracket member positioned against one side of the square tubing section, a section of the adjustable ruler ember positioned against an adjacent side of the square tubing section, and the gap between the rounded exterior corner of the square tubing section and the intersection of the vertical contact face and the adjustable ruler member.

FIG. 4 is a perspective view showing the end of a representative section of large square tubing with a section of the vertical contact face of the base bracket member positioned against one side of the square tubing section, a section of the adjustable ruler member positioned against an adjacent side of the square tubing section, and bottom contact face of the base bracket member facing upwardly.

### EXEMPLARY MODE FOR CARRYING OUT THE INVENTION

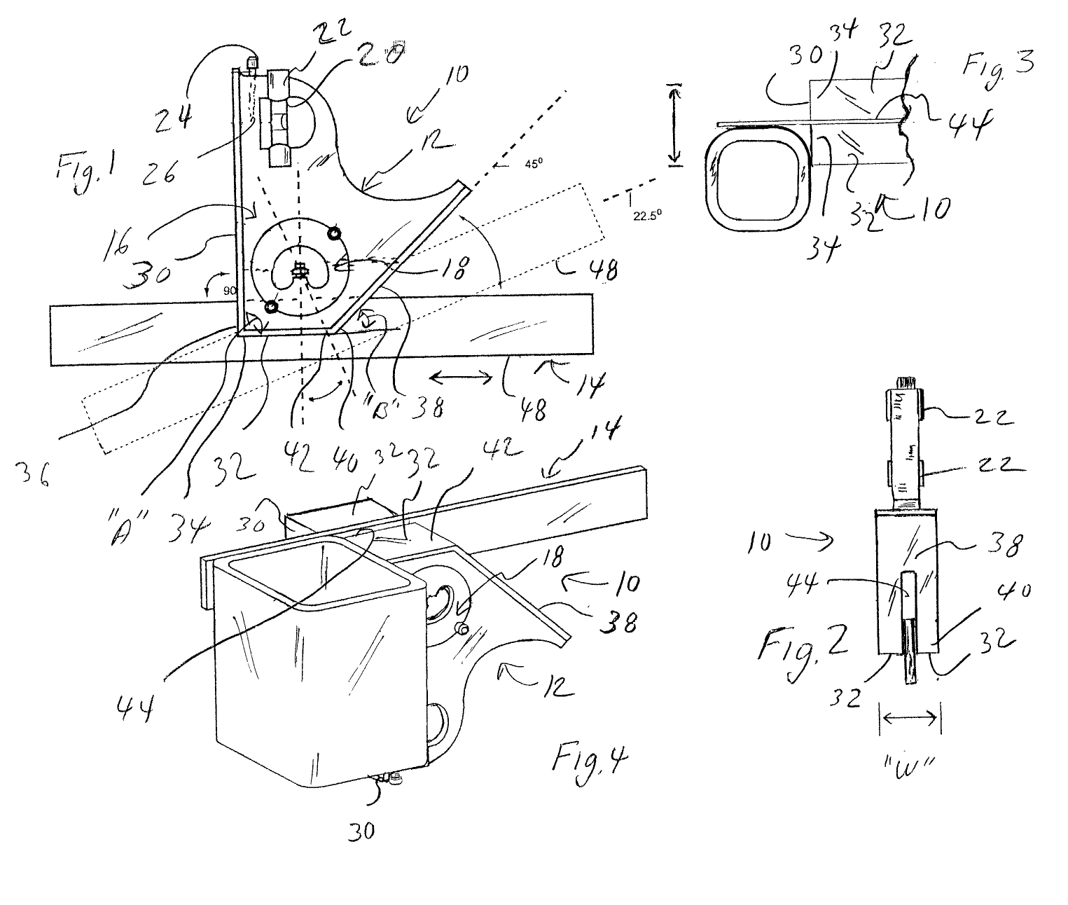

FIGS. 1-4 show various aspects of an exemplary embodiment of the combination square for large square tubing of the present invention generally designated 10. Combination square for large square tubing 10 includes a base assembly, generally designated 12, and an adjustable ruler member, generally designated 14, that is adjustably securable to base assembly 12.

Base assembly 12 includes a base member bracket, generally designated 16; a ruler member securing assembly, generally designated 18, for securing ruler member 14 at a desired orientation angle; a level vial 20 held within a vial holding racket 22 of base member bracket 16, and a scratch awl 24 removably insertable into a cavity 26 (shown in dashed lines) of base member bracket 16 for storage. Base member bracket 16 includes a planar, vertical contact face 30 having a width “W” greater than one and one-half inches; a planar bottom contact face 32 oriented at an angle “A” (FIG. 1) of ninety degrees with respect to vertical contact face 30 and having a first end edge 34 in connection with a vertical bottom end edge 36 of vertical contact face 30; a planar forty-five degree contact face 38 oriented at a forty-five degree angle “B” with respect to vertical contact face 30 and the plane of bottom contact face 32 and having an angled bottom end edge 40 in connection with a second end edge 42 of bottom contact face 32; and a ruler member receiving slot 44 formed entirely through bottom contact face 32 and through bottom sections of vertical contact face 30 and forty-five degree contact face 38 that is sized to receive a section of ruler member 14 at an orientation angle of between zero and twenty-two and one-half degrees. Vertical contact face 30, bottom contact face 32 and forty-five degree contact face 38 are equal in width. The orientation angle is defined as the angle between a bottom edge 48 of ruler member 14 and the plane defined by bottom contact surface 32. Ruler member 14 is held at the desired angle by ruler member securing assembly 18 which is conventional in construction and operation.

It can be seen from the preceding description that a combination square for large square tubing has been provided.

It is noted that the embodiment of the combination square for large square tubing described herein in detail for exemplary purposes is of course subject to many different variations in structure, design, application and methodology. Because many varying and different embodiments may be made within the scope of the inventive concept(s) herein taught, and because many modifications may be made in the embodiment herein detailed in accordance with the descriptive requirements of the law, it is to be understood that the details herein are to be interpreted as illustrative and not in a limiting sense.

What is claimed is:

1. A combination square for large square tubing comprising:
a base assembly; and
an adjustable ruler member securable to the base assembly;
the base assembly including:
a base member bracket,
a ruler member securing assembly for securing the ruler member at a desired orientation angle,
a level vial held within a vial holding bracket of the base member bracket, and
a scratch awl removably securable to the base member bracket;
the base member bracket including:
a planar, vertical contact face having a width greater than one and one-half inches,
a planar bottom contact face oriented at a ninety degree angle with respect to the vertical contact face and having a first end edge in connection with a vertical bottom end edge of the vertical contact face,
a planar forty-five degree contact face oriented at a forty-five degree angle with respect to the vertical contact face and the bottom contact face and having an angled bottom end edge in connection with a second end edge of the bottom contact face, and
a ruler member receiving slot formed entirely through the bottom contact face and through bottom sections of the vertical contact face and the forty-five degree contact face sized to receive a section of the ruler member at an orientation angle of between zero and twenty-two and one-half degrees;
the ruler member being held at the desired orientation angle by the ruler member securing assembly.
